(19) United States
(12) Patent Application Publication
(10) Pub. No.: US 2010/0068364 A1
(43) Pub. Date: Mar. 18, 2010

(54) COFFEE BEAN ROASTING MACHINE AND METHOD THEREFOR

(76) Inventors: Zev Mager, Raanana (IL); Joseph Reinberg, Hod-Hasharon (IL); Shlomo Dori, Kadima (IL)

Correspondence Address: YORAM TSIVION, P.O. BOX 1307, PARDES HANNA, 37111, IL

(21) Appl. No.: 12/210,910

(22) Filed: Sep. 15, 2008

(51) Int. Cl. A23F 5/04; A23N 12/12

(52) U.S. Cl. 426/468; 426/466; 99/470; 99/472

(57) ABSTRACT

Machine and process for roasting of coffee beans is disclosed. The process includes the step of rapidly depressurizing the beans. The machine includes at least one hermetically sealable receptacle for coffee beans. The receptacle is heated so that the pressure inside increased. The receptacle is then abruptly exposed to a substantially atmospheric pressure, thereby rapidly depressurizing the beans.

### FIELD OF THE INVENTION

The present invention, in general, relates to coffee bean roasting.

### BACKGROUND OF THE INVENTION

A diversity of roasting processes is known in the art. Batch-type roasting, continuous roasting, pressure roasting and fluidized-bed roasting are examples of categories of known roasting processes, used in food industry.

Coffee beans are roasted before consumption. The roasting process changes the coffee bean both physically and chemically, influencing the taste of the coffee products. The roasting process leads to chemical reactions resulting in changes of color, essence, aroma, and density of the coffee bean. The bean decreases in weight as moisture is lost and increases in volume, causing it to become less dense.

U.S. Pat. Nos. 3,615,668, 3,964,175, 6,564,470, 6,607,768 disclose methods for roasting coffee beans, nuts, cereals, grains and other foods in a fluidized-bed roasting process. U.S. Pat. No. 3,615,668 discloses a continuous process, whereas U.S. Pat. No. 3,964,175 discloses an apparatus that can be used for batch type or continuous processes. U.S. Pat. No. 3,214,844 discloses a method and apparatus for drying and roasting particles. U.S. Pat. No. 2,762,289 discloses apparatus for coffee roasting in bath type process. During roasting the vapors extracted from the coffee beans are collected, condensed, and returned to the coffee.

Roasting of the coffee beans results with the loss of some portion of the volatile and/or aromatic substances as they are evaporated; thus negatively affecting the quality of the end product.

### BRIEF DESCRIPTION OF THE DRAWINGS

The present invention will be understood and appreciated more fully from the following detailed description taken in conjunction with the appended drawings in which:

FIG. 1 is a flow chart describing a process of depressurization roasting of coffee beans in accordance with some preferred embodiment of the present invention;

FIG. 2 is a schematic cross-sectional view of a depressurization roasting machine implementing a batch-continues approach.

### SUMMARY OF THE INVENTION

In accordance with the present invention a process and machine for roasting of coffee beans is provided. The process includes a step of rapidly depressurizing the beans. The machine includes at least one hermetically sealable receptacle for coffee beans. The receptacle is heated so that the pressure inside increased. The receptacle is then abruptly exposed to a substantially atmospheric pressure, thereby rapidly depressurizing the beans.

### DETAILED DESCRIPTION OF THE PRESENT INVENTION

In accordance with some embodiments of the method of the present invention, roasting coffee beans is followed, or preferably terminated by depressurizing the beans, resulting in puffing of the beans and thereby in enhanced preservation and retention of volatile and other aromatic substances within the beans.

Rapid depressurization of the coffee beans, particularly subsequent to a pressure roasting, alters the physical composition of the beans in such a manner that more volatile and/or aromatic substances are captured and preserved within the processed beans' tissue. Furthermore, rapid depressurization of the coffee beans increases the volume and surface area and decreases the density thereof, thereby producing more porous and puffy beans from which a coffee drink is more efficiently and easily extracted, for instance by brewing or percolating.

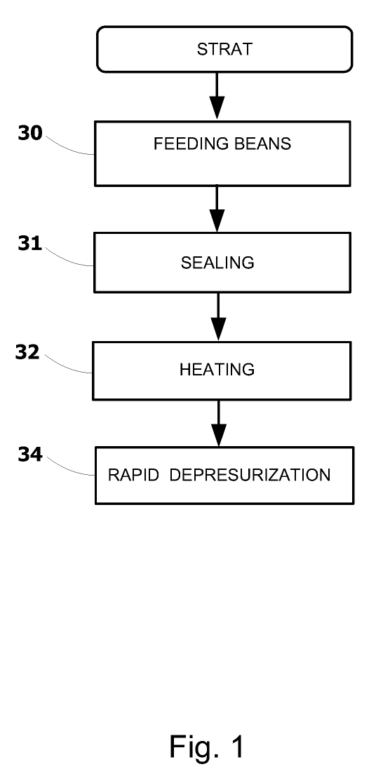

Reference is now made to FIG. 1, showing the sequence of steps of a process, in accordance with some preferred embodiments of the present invention. Firstly, in step 30, a predetermined quantity of coffee beans is fed into containers or compartments of a machine of the present invention. The beans are then hermetically sealed off at step 31. Subsequently, the hermetically sealed beans are heated at step 32. During at least a part of step 32, the beans remain hermetically sealed; the pressure within the containers or compartments increases and thus the beans themselves are subjected to pressure increase. Consequently, due to the increased temperature and pressure of step 32, the beans are subjected to pressure roasting. The beans are preferably stirred, agitated or otherwise mixed during step 32 to ensure a homogenous roasting thereof.

Preferably, the roasting of step 32 is terminated by rapid depressurization of the beans, at step 34. This can be achieved, inter alia, by an abrupt exposure to ambient atmospheric pressure, for instance by opening the aforementioned containers or compartments of the machine of the present invention, in which the beans are processed.

Upon the depressurization at step 34, a decrease in the temperature inside the containers or compartments occurs. However, the beans remain relatively hot at the end of depressurization step 34, with roasting continuing to some extent due to the thermal energy accumulated within the beans. In order to prevent excessive roasting, the beans are preferably cooled down, typically by directing a flow of cool air, which can be produced by a fan.

In accordance with the present invention, the roasting lasts typically between 5 to 40 minutes, temperatures attain typically a range of 150° C. to 350° C., and pressure ranges from 4 to 35 atmospheres.

### EXAMPLE 1

Two kilograms batches of green coffee beans were roasted in a pressure vessel. Heat was applied to the outside surface of the vessel by gas burners. The vessel was heated to a temperature between 200° C. to 300° C. and the pressure reached levels ranging between 12 and 20 atmospheres. At the end of the roasting, the pressure was instantly released by opening the cover of the vessel where the beans were contained. The roasted coffee beans were collected and allowed to cool down.

The roasted coffee beans were tested for weight to volume ratio and some of them ground for preparation of a coffee drink, in order to assess the sensory qualities of the end product, by comparing the coffee drink to a control prepared from conventionally roasted beans.

### Best Mode for Carrying Out the Invention

In accordance with some preferred embodiments, the machine that implements the method of the present invention includes at least one sealable container adapted to contain a batch of coffee beans. In some examples, the container is a metallic cylindrical container (MCC) having a circumferential flange at the top thereof, to which a lid can be sealingly engaged. The sealing engagement of the lid and the barrel is preferably secured by a mechanical securing mechanism (MSM) such as a dog or a detent, until such time as the securing mechanism is disabled by the forcement of a releasing mechanism. The releasing mechanism is situated along the production line, disabling the MSM by causing it to shift or knock down or slide away or any other means such as unlatching of a latch. Preferably the MCC is adapted to rotate along its longitudinal axis; thereby stirring the beans content and providing for a homogenous roasting. Accordingly, the MCC and/or the lid can be furnished with a pivot and/or trunnion/s facilitating the rotation of the barrel, typically as it advances along a conveyor chain.

The roasting is achieved by heating the barrel. For a pressure roasting, after the beans were dispensed into the barrel, the lid is sealingly engaged to the circumferential flange of the barrel, thereby hermetically closing it. Preferably, the barrels are heated while constantly rotating. Upon the heating, a pressure builds-up inside the barrels. Accordingly, the step of rapid depressurization can be achieved by releasing the lid from its sealing engagement with the barrel, thereby abruptly exposing the interior of the barrel and its content to an about atmospheric pressure. The releasing of the lid from its sealing engagement with the barrel can be done by actuating the detent, which secures the lid.

In some embodiments, a plurality of barrels is sequentially moved on by or along a conveyor chain while rotating around their horizontal axis. The barrels are heated as they move all along the conveyor chain.

Preferably, the barrels are depressurized by actuating the detent that secures the lid after the barrels have advanced a predetermined distance along the production line. The predetermined distance which the barrels advance with a velocity of the conveyor chain corresponds to a particular period of time needed to accomplish the roasting of the beans to a desired extent. The distance can be adjusted by repositioning the aforementioned jag and/or altering the velocity conveyor chain.

### Alternative Mode for Carrying Out the Invention

In accordance with some preferred embodiments of the machine that implements the method of the present invention, a batch-continuous approach is employed.

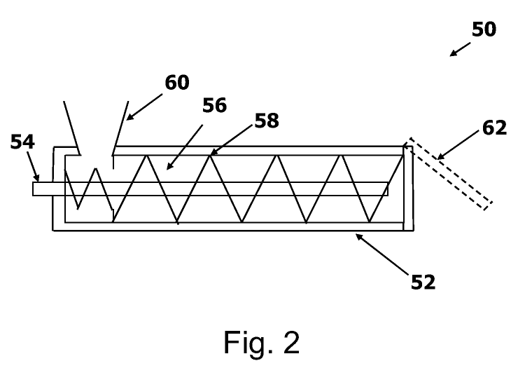

Reference is now made to FIG. 2, in which depressurization roasting machine 50 is shown. Machine 50 includes cylindrical receptacle 52. Within receptacle 52 pivot 54 is coaxially disposed. Pivot 54 is furnished with screw conveyor 56, thereby a screw motion can be applied onwardly advancing the beans inside receptacle 52 upon rotation of pivot 54. Outer edges 58 of screw conveyor 56 are preferably to sealingly adjoin the interior of receptacle 52. Receptacle 52 further includes inlet 60 for feeding the beans in and the respective outlet covered by.

The beans are initially fed into roasting machine 50 through inlet 60. A rotational torque is applied to pivot 54 and the beans are consequently onwardly advanced until receptacle 52 is filled. Receptacle 52 is then sealed from the ambient atmospheric environment, by sealing inlet 60 and engaging lid 62 to receptacle 52. A heat is subsequently applied to receptacle 52 facilitating pressure roasting of the beans. At the end of the roasting process lid 62 is disengaged from receptacle 52 and rotational torque once again applied to pivot 54 to dispense the beans from roasting machine 50.

In some embodiments of the present invention, during roasting the vapors extracted from the coffee beans are collected, and returned to the coffee, as known for those having ordinary skills in the art of the food industry.

It should be acknowledged that any type of heating means known in the art is applicable with various embodiments of the machine of the present invention, in a non-limiting manner including inter alia gas burners, oil burners, any type of fuel other oxidative burners, electrical heating means, stem heating or any other type of heating induced by convection.

### EXAMPLE 2

In the experimental setup used to produce the beans for the comparative testing of sensory qualities of a coffee drink prepared from the end product relatively to a control prepared from conventionally roasted beans, a high-pressure cylinder 250 mm in diameter and 400 mm in length was employed. The cylinder was fitted with a gear motor and constantly rotated. The cylinder was fitted with an openable cover flange, allowing insertion of coffee beans and instant relief of the pressure. The vessel was furnished with a pressure gauge and the temperature was measured by means of an infrared handheld thermometer.

### EXAMPLE 3

A batch of coffee beans prepared in the experimental setup and according to parameters detailed supra were used in comparative testing for sensory qualities of a coffee drink prepared from them, relatively to a coffee drink prepared from the green coffee beans from the same bag that were roasted by a common industrial process, a conventional drum roasting, which was used a standard. Bulk density or ratio of weight to volume of the beans prepared by depressurization roasting coffee beans was compared to the standard as well. The sensory qualities testing was conducted on a group of 15 participants by triple blind organoleptic tasting of the samples.

Between 30% to 80% of less bulk density, as compared to the standard, was observed in beans prepared by the depressurization roasting process of the present invention, depending on the particular parameters of the batch's preparation. In the organoleptic tasting trials, a prominent majority of the participants rated the coffee drink prepared from depressurization roasted beans as much stronger and aromatic as compared to the standard.

Thence a coffee drink was prepared from standard roasted coffee using standard measuring spoon and compared to a coffee drink prepared from half of that amount of depressurization roasted beans. The prominent majority of the participants hasn't distinguished between the control drink and the tested one.

### Benefits of Implementing the Invention

The sealed environment while heating the beans inside the barrel resulting in shortening the time of roasting; thus cuts down energy costs. The puffing of the beans achieves an enhanced preservation and retention of volatile and other aromatic substances within the beans. Grinding puffed coffee beans consumes less energy, as beans are porous and crispy. Depressurization roasting of coffee beans achieves a higher volume and lesser bulk density of the beans, allowing better extraction of the coffee in brewing or in espresso machines. Considerably lower amount by weight of ground depressurization roasting coffee beans is needed to prepare the same amount of coffee drink, of the same or better quality, strength and aroma. Hence the invention is prominently beneficial for a more efficient and economic consumption of coffee crops.

It will be appreciated that the present invention is not limited by what has been particularly described and shown hereinabove and that numerous modifications, all of which fall within the scope of the present invention, exist. Rather the scope of the invention is defined by the claims which follow:

1. A process for roasting coffee beans, said process comprising the steps of:
feeding said beans into a roasting machine;
hermetically sealing said beans within said machine;
heating said sealed beans;
rapidly depressurizing the beans, and
dispensing said beans;
whereby at least a decrease in bulk density of said beans is achieved.

2. The process of roasting coffee beans, as in claim 1, characterized further by temperature of said beans attaining a range from 150° C. to 350° C.; and also a pressure attaining a range from 4 to 35 atmospheres, and also by a duration from 5 to 40 min.

3. The process of roasting coffee beans, as in claim 1, further comprising a step of cooling down said beans following said step of depressurizing.

4. A machine for roasting coffee beans, said machine comprises:
at least one hermetically sealable container adapted to contain said coffee beans;
at least one matching lid hermetically engageable with said container, thereby sealing said beans within said container;
a releasable mechanical securing mechanism (MSM) for securing said lid hermetically engaged to said container, and
a heating source for heating said container;
wherein upon operating said heating means the pressure inside said container increases, and
wherein upon actuating said MSM, said lid is released abruptly exposing said beans to the ambient environment and thereby rapidly depressurizing them;
whereby at least a decrement in bulk density of said beans is achieved.

5. The machine for roasting coffee beans as in claim 4, further comprising a fan for cooling said beans following to depressurizing them.

6. The machine for roasting coffee beans as in claim 4, wherein said container is adapted to rotate about its longitudinal axis; thereby stirring the beans content thereof.

7. The machine for roasting coffee beans as in claim 4, wherein a plurality of said containers are movable by a conveyor chain along the production line.

8. The machine for roasting coffee beans as in claim 7, wherein said MSM is actuated by an interaction with a jog occurring upon advancement of a predetermined distance along said production line, and wherein said predetermined distance corresponds to a particulate period of time needed to accomplish the roasting of said beans to a desired extent.

9. A machine for continuous batch-roasting of coffee beans, said machine comprising:
at least one hermetically sealable cylindrical receptacle having a sealable inlet and a sealable outlet;
at least one screw conveyor, coaxially disposed within said receptacle, thereby a screw motion can be applied to said beans upon rotation of said conveyor, onwardly advancing them inside said receptacle;
a means of sealing said inlet of said receptacle;
a respectively matching lid hermetically engageable to said receptacle at said outlet thereof, thereby sealing said beans within said receptacle from the ambient environment, and
a heating source for heating said container;
wherein upon operating said heating means the pressure inside said receptacle increases, and
wherein upon opening said lid, said beans are abruptly exposed to the ambient environment and thereby rapidly depressurized;
whereby at least a decrement in bulk density of said beans is achieved.
